(19) United States
(12) Patent Application Publication
(10) Pub. No.: US 2023/0334966 A1
(43) Pub. Date: Oct. 19, 2023

(54) INTELLIGENT SECURITY CAMERA SYSTEM

(71) Applicant: IQBAL KHAN ULLAH, Denver, CO (US)

(72) Inventor: IQBAL KHAN ULLAH, Denver, CO (US)

(21) Appl. No.: 17/659,308

(22) Filed: Apr. 14, 2022

(51) Int. Cl. G08B 13/196; G06V 10/774; G06V 10/82; G06V 20/52

(52) U.S. Cl. CPC G08B 13/19613; G06V 10/774; G06V 10/82; G06V 20/52

(57) ABSTRACT

The present invention generally relates to improvements in security camera systems. In particular, the present invention relates to the use of machine learning techniques such as computer vision to improve the monitoring of security incidents, classify threat levels and prioritize threat visibility over general footage recording. According to one embodiment, an suitably trained machine learning algorithm is provided to analyze time-sequential series of camera footage to determine the activity, determine and classify incidents, classify the threat level in determined incidents and report the threat to an appropriate respondent. According to another embodiment, preferably in a multi-camera security setup, the footage where threatening incidents are determined are prioritized for monitoring over overall camera footage. Further, it is one embodiment of this invention to distinguish contextual events during the classification and determination of threats in security footage from security camera systems.

### FIELD OF INVENTION

The present invention generally relates to improvements in security camera systems. In particular, the present invention relates to the use of machine learning techniques such as computer vision to improve the monitoring of security incidents, classify threat levels and prioritize threat visibility over general footage recording.

### BACKGROUND OF THE INVENTION

The need for flexible and intelligent security infrastructure is in constant evolution as the security industry is seeking the deployment of technology to make operations secure and more efficient. The amount of security footage data generated can simply not be handled by human capacities anymore, which is why we have to rely on technology and analyse security footage on an evidence base. Moreover, safety requirements are ever-evolving, so any solution has to be flexible and investments need to deliver a return when circumstances and demands are changing.

Modern security cameras hare essential for detecting intrusion into restricted zones, detecting objects in a video feed from the camera, maintaining surveillance and even trigger alerts when incidents are detected from the surveillance footage. The most common types of security camera systems are CCTV, which are well known by those who practice the art of security camera systems. The most notable improvement to the art of CCTV security, and generally security camera systems is the incorporation of artificial intelligent (AI) for advanced video analytics.

AI CCTV cameras are network IP cameras that deliver advanced analytical functions like vehicle detection, face detection, person detection, people counting, traffic counting and license plate recognition (LPR). Advanced video analytics software is built into the camera and recorder, which then enables artificial intelligence functions.

For AI CCTV camera systems to work, camera footage is constantly sent to a recorder and processed via an AI layer to make sense of the raw video. For example, rule-based AI cameras are manually set up with rules and reference images such as humans in different postures, angles or movements. The AI will then ask itself if anything it observes looks and moves like this. Depending on the rules set, such as ‘no one is allowed in this area at a certain time,’ if the camera observes this, it may be configured to send an alert.

Some security camera systems are self-learning, such as those which use “behavioral analytics” software. Behavioral analytics AI analyzes normal behavior for an area and gradually builds up a definition of this typical behavior, which may include the size, speed and color of particular objects. It then normalizes the data, tagging any objects and patterns it observes. When something is observed to fall outside of this typical behavior, it may trigger security alerts, sound alarms or any set security measure. Several patent applications have made attempts at improving the technology as disclosed below:

For example, U.S. Pat. No. 9,928,707B2 discloses a surveillance system for monitoring movement in a region of interest. The surveillance system includes: An image capturing system having a field of view including a region of interest, and adapted to capture an image of the region of interest. An image processing system configured to process a time-sequential series of images of the field of view from the image capturing system such that at least a portion of each processed image is analyzed for detecting movement within the region of interest. The image capturing system is configured to capture, in each image, different apparent magnifications of respective zones within the region of interest in the field of view that are at different distances from the image capturing system such that an object in at least one position in at least two of said zones has substantially the same apparent size in the images.

On the other hand, KR101993632B1 discloses an apparatus for detecting intrusion, which monitors unauthorized intrusion attempts to a waste building, such as a waste factory where a person is no longer allowed due to bankruptcy or the like and a separate manager does not reside, and to a security system including the same. According to an embodiment of the present invention, by installing a prefabricated surface structure for a waste building due to bankruptcy, and by using a camera module to photograph the inside and outside of the building, the intrusion can be monitored in real time from a remote location without a separate resident.

However, all prior art does not determine the threat level in a footage, prioritize eventful footage over non-eventful footage, or determine alert reporting based on determined threat level.

### SUMMARY OF THE INVENTION

The following summary is an explanation of some of the general inventive steps for the system, method, architecture and apparatus in the description. This summary is not an extensive overview of the invention and does not intend to limit the scope beyond what is described and claimed as a summary.

The present invention generally relates to improvements in security camera systems. In particular, the present invention relates to the use of machine learning techniques such as computer vision to improve the monitoring of security incidents, classify threat levels and prioritize threat visibility over general footage recording.

According to one embodiment, an suitably trained machine learning algorithm is provided to analyze time-sequential series of camera footage to determine the activity, determine and classify incidents, classify the threat level in determined incidents and report the threat to an appropriate respondent.

According to another embodiment, preferably in a multi-camera security setup, the footage where threatening incidents are determined are prioritized for monitoring over overall camera footage.

Further, it is one embodiment of this invention to distinguish contextual events during the classification and determination of threats in security footage from security camera systems.

The current invention solves the problem that security camera systems currently available in the market do not determine the threat level in a footage, prioritize eventful footage over non-eventful footage, or determine alert reporting based on determined threat level.

According to one embodiment, the disclosed security camera system is configured capable of determining threats posed by people, pets or other objects, and classify them on a threat level index.

According to one embodiment, the disclosed security camera system comprises a suitably trained machine learning algorithm installed at each monitoring device/camera.

According to one embodiment, the disclosed security camera system comprises a suitably trained machine learning algorithm installed at a local central processing device operably coupled to a plurality of monitoring devices/cameras monitoring a substantially local location.

According to one embodiment, the disclosed security camera system comprises a suitably trained machine learning algorithm installed at a remote cloud processing system operably coupled to a plurality of monitoring devices/cameras monitoring a plurality of zones in different location.

According to one embodiment, the suitably trained machine learning algorithm is capable of improving its security monitoring by learning.

According to one embodiment, a threat classifier classifies the threat level of each detected incident and determines the appropriate respondent based on the threat level and transmits an appropriate alert.

For a more complete understanding of the above listed features and advantages of the intelligent security camera system, reference should be made to the detailed description and the drawings. Further, additional features and advantages of the invention are described in, and will be apparent from, the detailed description of the preferred embodiments.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 of the drawings illustrates a security camera setup comprising an improved machine learning layer according to one embodiment.

FIG. 2 of the drawings is an illustration of incident detection and threat reporting according to one embodiment.

FIG. 3 of the drawings is a process diagram illustrating one embodiment of the disclosed system.

FIG. 4 of the drawings is a flow diagram leading to the logging or reporting incidents from security footage.

FIG. 5 of the drawings is an exemplary implementation of the current invention according to one embodiment.

FIG. 6 of the drawings is a flow chart demonstration of the processing of footage data.

FIG. 7 of the drawings illustrates a simplified process of training a machine learning algorithm according to one embodiment.

FIG. 8 of the drawings illustrates a simplified process of training a machine learning algorithm according to one embodiment.

### DETAILED DESCRIPTION OF THE PREFERRED EMBODIMENTS

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

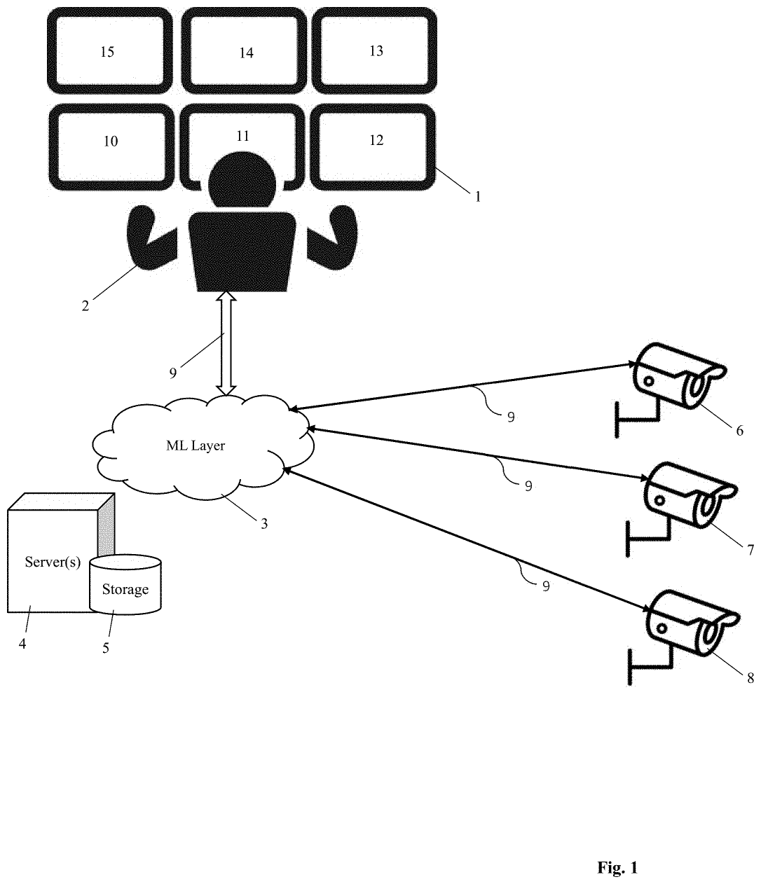

In a first embodiment according to the FIG. 1 of the drawings, it is illustrated a security camera setup comprising an improved machine learning layer according to one embodiment. On the figure, it is shown the monitor(s) 1, comprising a plurality of monitors 10, 11, 12, 13, 14 and 15, typical in a security control room for monitoring footage from one or more security cameras. It is noteworthy that a control room may also comprise only one monitor, with a plurality of windows for the linked security cameras. The operator 2 is shown in the same figure and is capable of at least monitoring footage from the cameras via the monitor(s) 1, or even including operating the cameras. Further shown in the figure is a machine learning layer 3, comprising a suitably trained machine learning algorithm capable of at least analyzing footage from one or more security cameras such as 6, 7 and 8 shown in the figure. The security cameras are linked via a data link 9, which in some embodiments may comprise a data transmission cable, a wireless data transmission mechanism or any such means capable of transmitting packets of data between any number of networked computing devices. The machine learning layer comprises an executable layers processable by at least a processor. As such, it is shown a server 4 and storage device 5, the storage device being capable of storing footage received from one or more of the security cameras.

According to one embodiment, security footage is received from the one or more security cameras 6, 7 and 8 shown in the figure and is stored in the storage device 5. The server 4, shown in the figure comprises at least a processor, a memory, and is capable of executing the suitably trained machine learning algorithm comprising the machine learning layer 3, also shown in the figure. The layer improves the monitoring of security incidents by classifying threat levels and prioritizing threat visibility over general footage recording, such that identified threats are prioritized for monitoring on the interface 1 by the operator 2. Specifically, and according to one embodiment, a suitably trained machine learning algorithm is provided to analyze time-sequential series of camera footage received from the cameras 6, 7 and 8 to determine the activity, determine and classify incidents, classify the threat level in determined incidents and report the threat to an appropriate respondent.

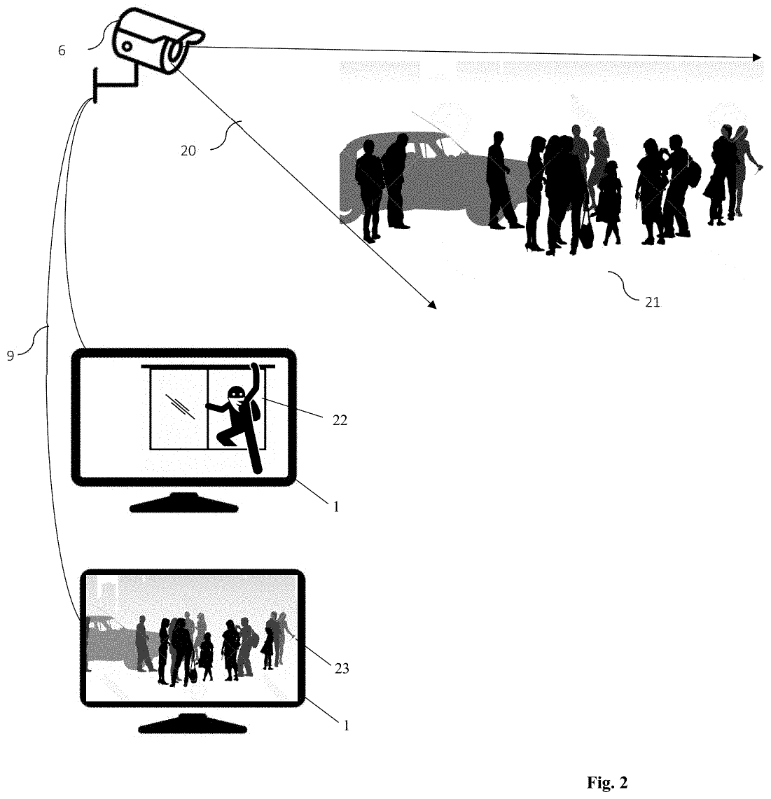

Referring to FIG. 2 of the drawings is an illustration of incident detection and threat reporting according to one embodiment. In the figure, it is shown a security camera 6 having a filed of view 20 where it captures an activity 21 also shown in the figure. In prior art implementation, the entire footage would be made available for monitoring at the monitoring interface 1 once transmitted via the data link 9. However, according to one embodiment of the current invention, the footage or the general activity within the field of view is passed through the machine learning layer for incident detection, such that an incident is determined and if it is of interest or poses a security threat, it is prioritized for monitoring such as the example break-in shown as 22 in the figure. The suitably trained machine learning algorithm is provided to analyze time-sequential series of camera footage to determine the activity, determine and classify incidents, classify the threat level in determined incidents and report the threat to an appropriate respondent. In the example shown, the footage where threatening incidents are determined are prioritized for monitoring over overall camera footage as such, making the incident 22 easier to detect. This has the effect that less manpower is required to ensure proper detection of threats as they happen, and also improves security by removing the need for a human operator to detect the incident as they may not always be up to the task, or there may be too much activity for them to keep up. The general footage is shown as 23, where incidents are not prioritized and thus would require a human operator to be keen and monitor hours of footage before incidents are detected.

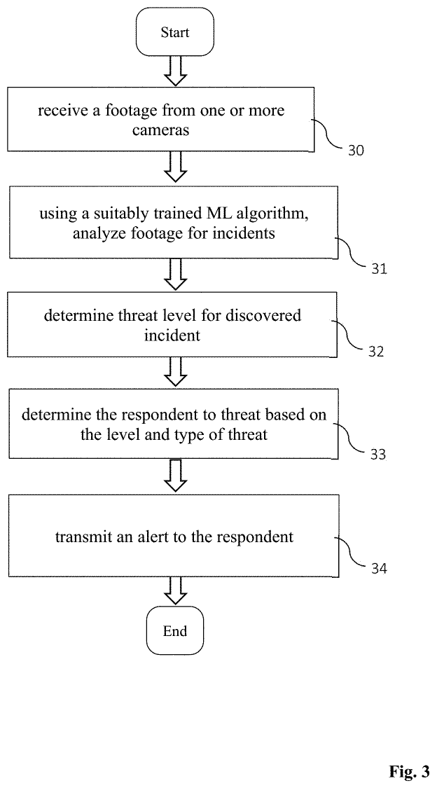

On the other hand, the embodiment illustrated by FIG. 3 of the drawings is a process diagram illustrating one embodiment of the disclosed system. The step 30 of the process is receiving a footage from one or more cameras. The subsequent step 31 is the utilization of a suitably trained machine learning algorithm, analyze footage for incidents. The step 32 is the determination of threat level for discovered incident of the previous step where such incidents are present. In the next step 33, is the determining of the respondent to threat based on the level and type of threat, where threats are present. Finally, in the step 34 is transmission of an alert to the respondent. This process implemented by a trained machine learning algorithm solves the problem that security camera systems currently available in the market do not determine the threat level in a footage, prioritize eventful footage over non-eventful footage, or determine alert reporting based on determined threat level. For example, the system may be configured capable of determining threats posed by people, pets or other objects, and classify them on a threat level index.

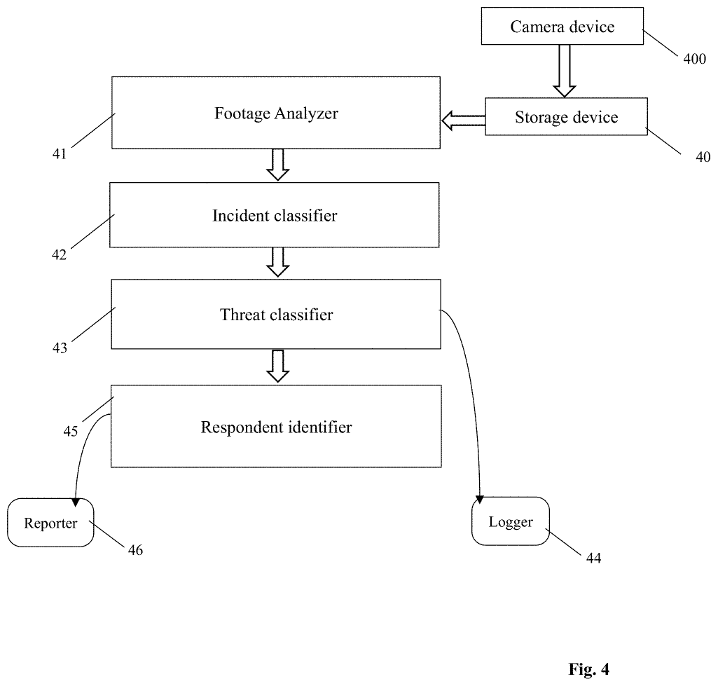

In the embodiment according to FIG. 4 of the drawings is a flow diagram leading to the logging or reporting incidents from security footage. Starting with at least one camera, illustrated as 400 to take surveillance, the footage is stored in a storage device 40, temporarily or permanently. A footage analyzer 41 analyzes the footage for incidents based on a learning model, an incident classifier 42 classifies incidents based on a learning model or a set of rules to determine threats and non-threats. A threat classifier classifies identified threats on a threat index, ranking risks from a lowest risk index to a highest risk index. Low risks may be logged by a logger 44, as these may not necessarily require deployment of a lot of resources to monitor but are nonetheless important to look into. For example, mere momentary trespass in a medium security zone may not be a very severe security incident until something drastic happens in future where such logs may be important to analyze. A respondent identifier 45 determines the relevant respondent based on the threat index of the identified threat. For example, certain risks may require the attention of the operator, other risks would require the attention of the security guards, other risks may require the attention of the police. The reporter 46 will report the security risk to the relevant respondent based on a threat index.

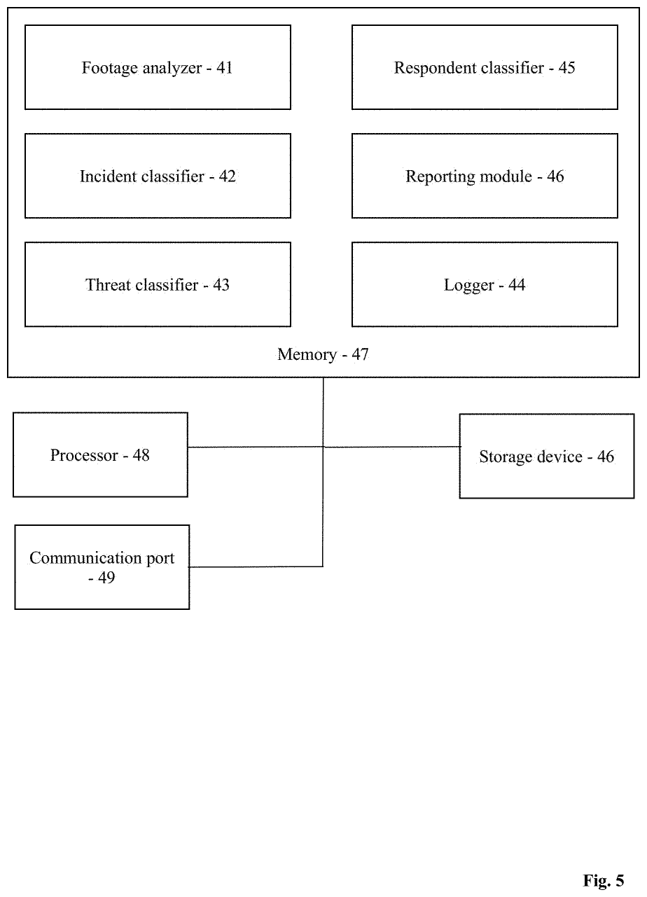

Now referring to FIG. 5 of the drawings is an exemplary implementation of the current invention according to one embodiment. On the figure, it is shown a memory 47, a processor 48, a storage device 46 and communication port 49. On the memory 47 several modules are configured, the modules being executable by at least a processor. They include footage analyzer 41, incident classifier 42, threat classifier 43, logger 44, respondent classifier 45 and reporting module 46. The modules comprise a suitably trained machine learning algorithm. According to one embodiment, the suitably trained machine learning algorithm may be installed at each monitoring device/camera such as camera 6 of FIG. 1.

According to another embodiment, the suitably trained machine learning algorithm may be installed at a local central processing device operably coupled to a plurality of monitoring devices/cameras such as camera 6, 7 and 8 of FIG. 1, monitoring a substantially local location.

According to yet another embodiment, the suitably trained machine learning algorithm may be installed at a remote cloud processing system operably coupled to a plurality of monitoring devices/cameras monitoring a plurality of zones in different location.

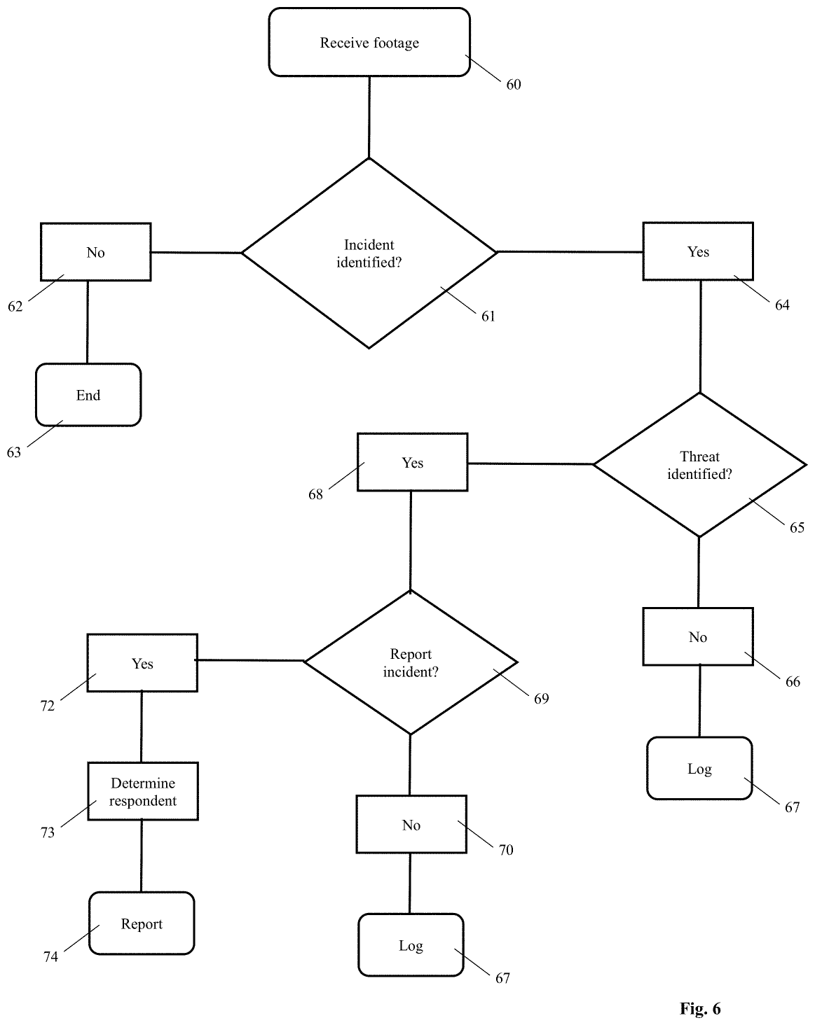

The embodiment of FIG. 6 of the drawings is a flow chart demonstration of the processing of footage data. A footage is received from at least a security camera in the step 60. A trained machine learning algorithm process the video to identify an incident from the received footage as in 61. If no incidents are identified as in 62, the process ends in 63. However, if incidents are identified as in 64, the incident is analyzed for threats in the step 65. Examples of threats could be break-ins, violence, theft, fights, carrying weapons, trespass among others. However, the specific threat depends on the security situation and the implementation requirements. Where there are no identified threats as in 66, the incident may be logged for later review as in 67. Where a threat is identified as in 68, the threat is passed through a reporting analyzer as in 69, to determine if the threat is worth reporting. If it is determined that the threat is not worth reporting as in 70, the threat may be logged later review as in 67. The determination to report a threat is based on a threat index, where low threats may be ignored, while high threats such as break-ins or weapons in a restricted area are reported.

Where it is determined that a threat has a high enough index for reporting as in 72, it is further determined the proper respondent to receive the threat report as in 73. the proper respondent then receives the threat report as in 74.

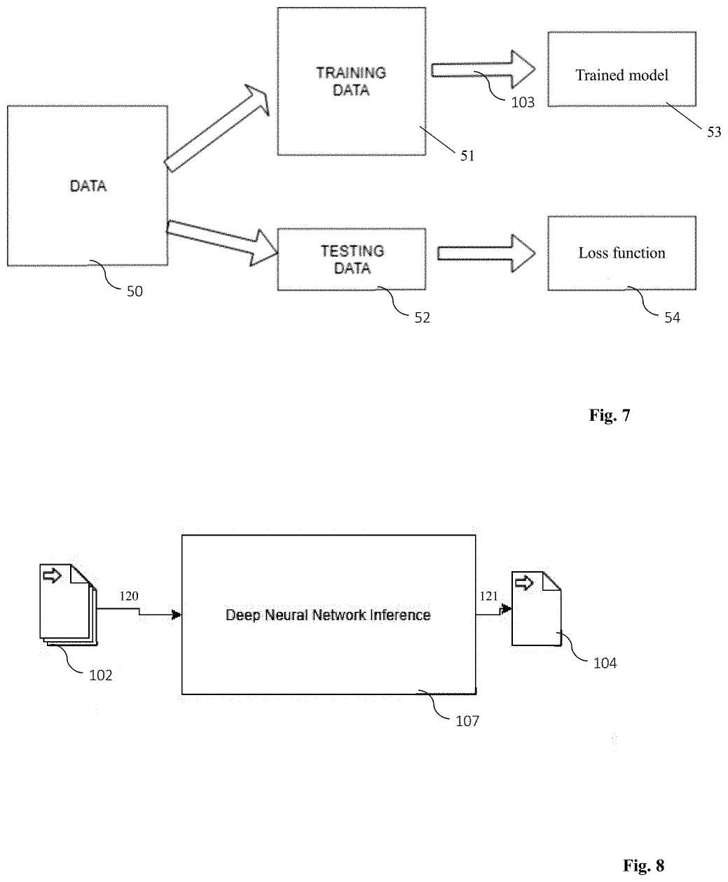

Referring to FIG. 7 of the drawings, it is illustrated a simplified process of training a machine learning algorithm according to one embodiment. In this exemplary illustration machine learning is performed by pattern recognition achieved by utilizing the concept of learning. Learning enables a pattern recognition model 53 to be trained and to become a trained model adaptable to analyze footage and provide accurate inference of threats and incidents. Preferably, security footage with example incidents and threats is gathered from a variety of sources, illustrated as 50 and preferably divided into a training dataset 51, and testing dataset 52. A section of the dataset, 51 is used for training the system while the rest, 52 is used for testing it. The training set contains labeled footage data, and is used for evaluation while training or building the model. Training rules may be provided to an untrained algorithm are used to provide the criteria for output decisions. Training algorithms are used to match a given input data with a corresponding output decision. The algorithms and rules are then applied to facilitate training. The algorithm uses the information collected from the data to generate a trained model 53. The testing set is used to validate the accuracy of the system. The testing data is used to check whether the accurate output is attained after the model has been trained to generate a loss function 54, that is then used to retrain the model. This data typically represents approximately 20% of the entire gathered data in the pattern recognition system.

To further exemplify this, the training of a machine learning engine to perform pattern extraction on data that may include structured and unstructured data. It is shown ground truth (testing data) data 21, an untrained algorithm capable of determining a pattern associated with ground truth data (labeled data). The training data is provided to the untrained machine learning engine as in 103. A generator in the untrained machine learning engine 103 attempts to extract patterns such as the correlation between use of certain words and phrases and the mental health or severity thereof from the training data. Preferably, a discriminator is then utilized to determine the loss function 54, wherein the extracted pattern of the trained model 53 is provided for comparison with ground truth data 52. The loss function is passed back to the untrained machine learning engine 103 improve the model until the model is capable of pattern extraction capability deemed equivalent to the ground data 52 by the discriminator (i.e. can fool the discriminator as a ground truth) with the required accuracy.

In this disclosure, the illustrations favor the use of a Convolution Neural Network for the machine learning algorithm, however, it is anticipated that any algorithm with an acceptable accuracy is also anticipated, and this may include other neural networks, classifiers, computer vision algorithms, Statistical algorithm, Structural algorithms, Template matching algorithms, Fuzzy-based algorithms, Hybrid algorithms, Deep Neural Networks, Feature Space Augmentation & Auto-encoders, Generative Adversarial Networks (GANs), and Meta-Learning.

Now referring to the FIG. 8 of the drawings is an illustration of the use of a trained machine learning engine to make an inference on the emotional state and/or mental health. In that embodiment, it is shown the use of the trained machine learning engine 107 to extract patterns and features of a character from a data source, where it is provided a data input(s) 102, comprising of a structured or unstructured footage. Once received the trained program performs feature and/or pattern extraction, based at least in part on the data input(s), the extracted features shown as 104. The extracted features may be used to infer an incident in the footage, the threat and threat level.

According to one embodiment, a threat classifier classifies the threat level of each detected incident and determines the appropriate respondent based on the threat level and transmits an appropriate alert.

It is anticipated that the disclosed system may to distinguish contextual events during the classification and determination of threats in security footage from security camera systems.

For example, the presence of masked men during Halloween may not trigger any threat assessments.

It is anticipated that the footage where threatening incidents are determined are prioritized for monitoring over overall camera footage.

Although a preferred embodiment of the present invention has been described for illustrative purposes, those skilled in the art will appreciate that various modifications, additions and substitutions are possible, without departing from the scope and spirit of the invention as disclosed in the accompanying claims. Such alterations are herewith anticipated.

Accordingly, the applicant intends to embrace all such alternatives, modifications, equivalents and variations that are within the spirit and scope of the disclosed subject matter. It should also be understood that references to items in the singular should be understood to include items in the plural, and vice versa, unless explicitly stated otherwise or clearly from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

### INDUSTRIAL APPLICATION

The invention is applicable in the security industry. The invention is applicable in the manufacture of security cameras and surveillance systems.

What is claimed is:

1. A system for security camera footage assessment, the system comprising of:
a security camera positioned to take footage of an area or venue;
a monitoring means capable of displaying footage from the security camera;
a data link connecting the security camera and the monitoring means; and
a computing device configured with a suitably trained machine learning algorithm, said algorithm executable by at least a processor, the execution of which implements the steps of:
receiving a footage from the security camera;
determining incidents from the received footage;
determining threats from the determined incidents; and
determining a threat level from the determined threat.

2. The security system of claim 1, wherein threats are prioritized for monitoring by the monitoring means.

3. The security system of claim 1, wherein determined risks are logged for later review.

4. The security system of claim 1, wherein threats are determined based on a threat index from low to high.

5. The security system of claim 4, wherein threat reporting is based on the threat index.

6. The security system of claim 1, wherein the suitably trained machine learning algorithm evolves by learning.

7. A security a footage assessment device comprising of:
a security means for taking security footage of an area or venue;
a computing means configured with a suitably trained machine learning algorithm, said algorithm executable by at least a processor, the execution of which implements the steps of:
receiving a footage from the security means;
determining incidents from the received footage;
determining threats from the determined incidents; and
determining a threat level from the determined threat.

8. The device of claim 7, wherein threats are prioritized for monitoring by the monitoring means.

9. The device of claim 7, wherein determined risks are logged for later review.

10. The device of claim 7, wherein threats are determined based on a threat index from low to high.

11. The device of claim 7, wherein threat reporting is based on the threat index.

12. The device of claim 7, wherein the suitably trained machine learning algorithm evolves by learning.

13. A method of security footage analysis comprising of:
receiving a footage of an area or venue from a security camera;
using a suitably trained machine learning algorithm, determining an incident in the received footage;
determining a threat from the determined incident; and
determining a threat level from the determined threat.

14. The method of claim 13, wherein threats are prioritized for monitoring by the monitoring means.

15. The method of claim 13, wherein determined risks are logged for later review.

16. The method of claim 13, wherein threats are determined based on a threat index from low to high.

17. The method of claim 13, wherein threat reporting is based on the threat index.

18. The method of claim 13, wherein the suitably trained machine learning algorithm evolves by learning.

19. The method of claim 13, wherein the training of the suitably trained machine learning algorithm comprises the steps of:
receiving by an untrained learning algorithm a plurality of gathered data inputs from a plurality of labeled security footage;
extracting a pattern of incidents based in part on the labeled security footage;
extracting a pattern of threats based in part on the incidents in the labeled security footage;
classifying the threat level of extracted threats;
generating for an untrained learning algorithm a pattern extraction model based upon the extracted incidents and threats extracting pattern; and
outputting a trained learning algorithm based at least in part the generated pattern extraction model.

20. The method of claim 19, further comprising evolving the pattern extraction model by learning.
